(19) United States
(12) Patent Application Publication
(10) Pub. No.: US 2026/0061422 A1
(43) Pub. Date: Mar. 5, 2026

(54) PERSONAL TEST UNITS FOR HEALTH MONITORING

(71) Applicant: GlobalFoundries U.S. Inc., Malta, NY (US)

(72) Inventor: William Taylor, Clifton Park, NY (US)

(21) Appl. No.: 18/824,990

(22) Filed: Sep. 5, 2024

(51) Int. Cl. B01L 3/00; G01N 21/03

(52) U.S. Cl. CPC B01L 3/502715; G01N 21/0303; B01L 2200/025; B01L 2200/028; B01L 2200/04; B01L 2300/0654; B01L 2300/0663; G01N 2021/0325

(57) ABSTRACT

Personal test units and methods of using a personal health unit for performing a health-monitoring test. The structure comprises a housing including a first interior chamber and a second interior chamber. The first interior chamber is configured to removably receive a sensor chip, and the second interior chamber is configured to removably receive a module that includes a plurality of reservoirs each containing a fluid. A microfluidic circuit is configured to couple the plurality of reservoirs to a plurality of sensing devices on the sensor chip. The structure may optionally include a light source that is disposed inside the housing. The light source may include a laser and a plurality of optical fibers configured to transfer light from the laser to the sensing devices on the sensor chip.

### BACKGROUND

The disclosure relates to personal test units for health monitoring and methods of using a personal health unit for performing a health-monitoring test.

At-home health tests may be self-administered using a test unit in the comfort of an individual's own home. Typically, an at-home health test requires the collection of a small sample of a bodily fluid, such as a blood sample gathered by using a finger prick similar to those used to check blood glucose levels. The collected bodily fluid sample may be placed on a sensor chip and analyzed by the test unit with the results displayed by the test unit to the individual. Alternatively, the sensor chip carrying the collected bodily fluid sample may be sent to a designated lab for analysis and, ultimately, reporting of the results to the individual or the individual's physician. In this manner, an individual can monitor some aspect of their health without the inconvenience of making appointments or visiting a lab in person.

A problem with conventional at-home health tests is that the surface-preparation chemistries on the sensor chip that can withstand the time lag between when prepared at the factory and the time of use. The surface-preparation chemistries must also survive the packaging at the factory and delivery to the individual.

Improved personal test units and methods of using a personal health unit for performing a health-monitoring test are needed.

### SUMMARY

In an embodiment of the invention, a structure for a personal test unit is provided. The structure comprises a housing including a first interior chamber and a second interior chamber. The first interior chamber is configured to removably receive a sensor chip, and the second interior chamber is configured to removably receive a module that includes a plurality of reservoirs each containing a fluid. A microfluidic circuit is configured to couple the plurality of reservoirs to a plurality of sensing devices on the sensor chip. The structure may optionally include a light source that is disposed inside the housing. The light source may include a laser and a plurality of optical fibers configured to transfer light from the laser to the sensing devices on the sensor chip.

In an embodiment of the invention, a structure for use with a personal test unit is provided. The apparatus comprises a module configured to be inserted into the personal test unit. The module includes a plurality of reservoirs, and at least one of the reservoirs contains a solution comprising a bio-functionalization chemistry.

In an embodiment of the invention, a method of administering a health-monitoring test is provided. The method comprises inserting a sensor chip into a personal test unit, delivering a solution comprising a bio-functionalization chemistry from a reservoir to a surface of the sensor chip after the sensor chip is inserted into the personal test unit, and analyzing a sample of a bodily fluid placed on the surface after the solution is delivered to the surface.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a diagrammatic view of a personal test unit in accordance with embodiments of the invention.

FIG. 2 is a diagrammatic view of a module for use with a personal test unit in accordance with embodiments of the invention.

FIG. 3 is a diagrammatic view of a microfluidic module for use with a personal test unit in accordance with embodiments of the invention.

FIG. 4 is a diagrammatic view of a sensor chip for use with a personal test unit in accordance with embodiments of the invention.

### DETAILED DESCRIPTION

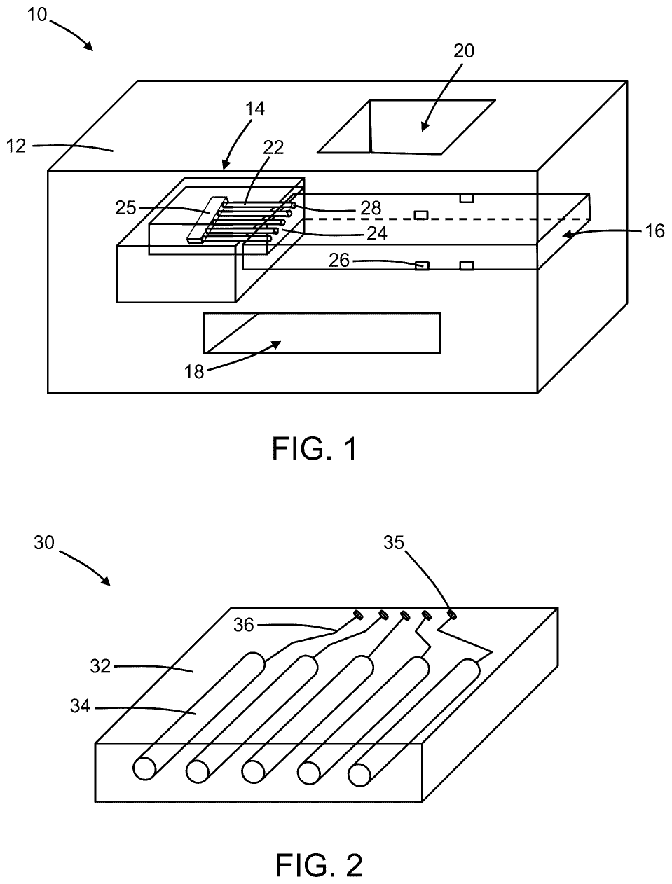

With reference to FIG. 1 and in accordance with embodiments of the invention, a personal test unit 10 includes a housing 12 and a light source 14 that is disposed inside the housing 12. The housing 12 includes an interior chamber 16 and an associated opening in the housing 12 that provide a pathway from the exterior environment to the interior chamber 16. The housing 12 includes an interior chamber 18 and an associated opening in the housing 12 that provide a pathway from the exterior environment to the interior chamber 18. The housing 12 includes an interior chamber 20 and an associated opening in the housing 12 that provide a pathway from the exterior environment to the interior chamber 20. The personal test unit 10 may be dimensioned to be portable for deployment to provide rapid, point-of-care medical diagnostics.

The light source 14 of the personal test unit 10 may include multiple optical fibers 22 that are arranged in an optical fiber array and a laser 25 configured to output light to the input ends of the optical fibers 22. In embodiments, the laser 25 may be configured to generate and emit continuous laser light in a visible wavelength range or in an infrared wavelength range. The optical fibers 22 may have output ends 28 that terminate along an interface 24 of the light source 14 that places the optical fibers 22 in communication with a portion of the interior chamber 16. Light originating as electromagnetic radiation from the light source 14 may be output by the output ends 28 of the optical fibers 22 into the portion of the space inside the interior chamber 16.

Alignment motors 26 may be arranged at various locations adjacent to the interior chamber 16. The alignment motors 26 may be used to adjust the position of a sensor chip 50 (FIG. 4) inserted into the interior chamber 16 in order to align light coupling structures 51 on the sensor chip 50 with the output ends 28 of the optical fibers 22.

With reference to FIG. 2 and in accordance with embodiments of the invention, the personal test unit 10 may include a module 30 having a housing 32 and multiple reservoirs 34 that are enclosed inside the housing 32. In an embodiment, the module 30 may be dimensioned and shaped to be inserted through the opening in the housing 12 into the interior chamber 18 in the housing 12 of the personal test unit 10 and thereby removably received by the personal test unit 10. In an embodiment, at least one of the reservoirs 34 may contain a fluid or solution comprising a bio-functionalization chemistry as a reagent. In an alternative embodiment, each reservoir 34 may contain a fluid or solution comprising a bio-functionalization chemistry as a reagent.

Ducts 36 couple the reservoirs 34 in fluid communication with respective outlets 35 at a side edge of the housing 32. The ducts 36 can direct the solutions from the reservoirs 34 to the outlets 35 to perform a bioassay. In an embodiment, the module 30 may be configured to be disposable after the reservoirs 34 are emptied of their solutions or otherwise in a state ready to be discarded. In an embodiment, the module 30 may be configured to be reusable after the reservoirs 34 are emptied of their solutions or otherwise in a state ready to be discarded.

In an embodiment, the bio-functionalization chemistry solutions held as reagents by the reservoir 34 may be comprised of bio-receptors dissolved in a solution. Each bio-functionalization chemistry solution provides a specific biological function that can be enabled on a surface. In an embodiment, at least one of the reservoirs 34 of the module 30 may contain a pre-clean chemistry in the form of a fluid or solution that can be used to clean and prepare a surface to receive one of the bio-functionalization chemistries. In an alternative embodiment, each reservoir 34 of the module 30 may contain a pre-clean chemistry in the form of a fluid or solution that can be used to clean and prepare a surface to receive one of the bio-functionalization chemistries. In an alternative embodiment, at least one of the reservoirs 34 of the module 30 may contain a solution comprising a bio-functionalization chemistry, and at least one of the reservoirs 34 of the module 30 may contain a solution comprising a pre-clean chemistry.

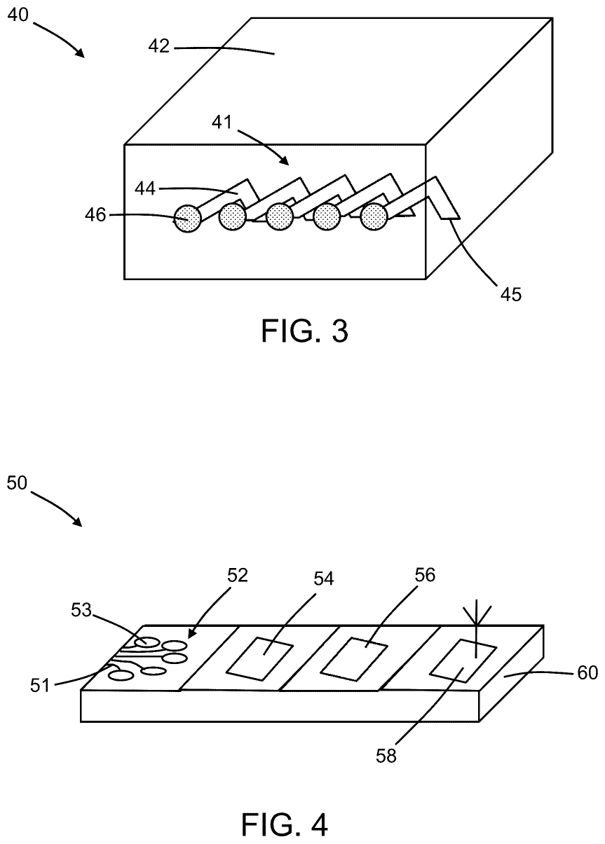

With reference to FIG. 3 and in accordance with embodiments of the invention, the personal test unit 10 may include a microfluidic module 40 having a housing 42 and a microfluidic circuit 41 inside the housing 42. In an embodiment, the microfluidic module 40 may be dimensioned and shaped to be inserted into the interior chamber 20 in the housing 12 of the personal test unit 10 and thereby removably received by the personal test unit 10. The microfluidic circuit 41 may include microfluidic structures 44 that have inlets 46 configured to be coupled with the outlets 35 from the ducts 36 of the module 30. The microfluidic structures 44 may include microchannels that are configured to confine and transport small volumes of fluids, such as femtoliters of fluid, from the reservoirs 34 of the module 30 to outlets 45 that deliver the fluids to sensing devices 53 on the sensor chip 50 inserted into the interior chamber 16. In an embodiment, the number of microfluidic structures 44 may be equal to the number of reservoirs 34 and ducts 36 such that each microfluidic structure 44 provides a pathway for transporting the bio-functionalization chemistry inside one of the reservoirs 34. In an embodiment, the microfluidic module 40 may be configured to be disposable. In an embodiment, the microfluidic module 40 may be configured to be reusable.

With reference to FIG. 4 and in accordance with embodiments of the invention, a sensor chip 50 may include a substrate 60 that is dimensioned and shaped to be inserted into the interior chamber 16 in the housing 12 of the personal test unit 10 and thereby removably received by the personal test unit 10. The sensor chip 50 may include a photonic integrated circuit 52 that is deployed on a portion of the substrate 60. The photonic integrated circuit 52 may include light coupling structures 51 that are configured to be edge coupled with the output ends 28 of the optical fibers 22 at the interface 24 when the sensor chip 50 is inserted into the interior chamber 16 in the housing 12 of the personal test unit 10. Each light coupling structure 51 may be configured to receive light of a given mode from the output end 28 of one of the optical fibers 22. In an embodiment, the number of light coupling structures 51 may be equal to the number of optical fibers 22.

The photonic integrated circuit 52 may include sensing devices 53 that are configured to receive light from the light coupling structures 51. The sensing devices 53 may be configured to receive a sample of a bodily fluid, such as a sample of blood extracted from a pin prick with the assistance of a lancet, in an environment external to the housing 12 of the personal test unit 10. The sensor chip 50 may be inserted into the opening associated with the interior chamber 16 with the bodily fluid sample applied to the sensing devices 53. In an embodiment, the sensing devices 53 may be interferometers. In an embodiment, the sensing devices 53 may be ring resonators. The microfluidic structures 44 in the microfluidic circuit 41 of the microfluidic module 40 permit fluids to be distributed from the reservoirs 34 of the module 30 to the sensing devices 53 of the sensor chip 50.

The sensor chip 50 may include circuitry 54 that is deployed on a portion of the substrate 60. The circuitry 54 may include an integrated circuit be configured to communicate with a motion controller for the alignment motors 26. The circuitry 54 may function to operate the alignment motors 26 for aligning the light coupling structures 51 of the photonic integrated circuit 52 with the output ends 28 of the optical fibers 22 at the interface 24 when the sensor chip 50 is inserted into the interior chamber 16 in the housing 12 of the personal test unit 10. In an embodiment, the alignment may occur automatically when the sensor chip 50 is inserted into the interior chamber 16 in the housing 12 of the personal test unit 10.

The sensor chip 50 may include circuitry 56 that is deployed on a portion of the substrate 60. The circuitry 56 may include a processor, a memory, and an input/output interface that provides communication with the photonic integrated circuit 52. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored as data in the memory. The memory may include one or more memory devices including, but not limited to, read-only memory, random-access memory, volatile memory, non-volatile memory, static random-access memory, dynamic random-access memory, flash memory, cache memory, or any other device capable of data storage.

The circuitry 56 may be configured to analyze data received from the photonic integrated circuit 52 and generate results. The data may be received from the photonic integrated circuit 52 as either optical signals or electrical signals. In an embodiment, the circuitry 58 may analyze the data by machine learning that involves an algorithm configured to analyze the data to identify patterns and generate models for analyzing data without direct instructions.

The sensor chip 50 may include circuitry 58 that is deployed on a portion the substrate 60. In an embodiment, the circuitry 58 may include a radiofrequency integrated circuit that is configured to communicate the results of the analysis to a remote device for capture, display, and storage.

In use, a personal test unit 10 may be employed to perform a method of administering a health-monitoring test. The sensor chip 50 may be inserted into the personal test unit 10. A solution comprising a bio-functionalization chemistry may be delivered from one of the reservoirs 34 to a surface of the sensor chip 50, such as a portion of the sensor chip 50 including one of the sensing devices 53, after the sensor chip 50 is inserted into the personal test unit 10. A sample of a bodily fluid may be placed on the surface of the sensor chip 50 may be analyzed after the solution is delivered to the surface. The analysis may be provided by transferring light from the light source 14 to the sensing device 53 on the sensor chip 50. The light may be transferred by a light coupling structure 51 from a laser 25 to the sensing device 53 on the sensor chip 50. A solution comprising a preclean chemistry may be delivered to the surface before the solution comprising the bio-functionalization chemistry is delivered to the surface.

The personal test unit 10 may allow maximum reliability and/or maximum repeatability because since all bio-functionalization chemistries may be sealed until the time of use. The personal test unit 10 may allow minimum cost to the consumer. For example, providing the bio-functionalization chemistries in a module 30 may be cheaper than inserting the bio-functionalization chemistries directly onto a chip. The delivery of the bio-functionalization chemistries at the point of use opens up a larger number of potential bio-functionalization chemistries for surface preparation and thus may enable greater test sensitivity. The delivery of the bio-functionalization chemistries at the point of use also potentially allows more diseases to be detected and/or more diseases to be detected at an earlier stage.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. Different features may “overlap” if a feature extends over, and covers a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a personal test unit, the structure comprising:
a housing including a first interior chamber and a second interior chamber, the first interior chamber configured to removably receive a sensor chip, and the second interior chamber configured to removably receive a module that includes a plurality of reservoirs each containing a fluid; and
a microfluidic circuit configured to couple the plurality of reservoirs to a plurality of sensing devices on the sensor chip.

2. The structure of claim 1 further comprising:
a light source inside the housing, the light source including a laser and a plurality of optical fibers configured to transfer light from the laser to the plurality of sensing devices on the sensor chip.

3. The structure of claim 2 wherein the plurality of optical fibers include respective output ends that are configured to be coupled inside the first interior chamber with a plurality of light coupling structures of a photonic integrated circuit on the sensor chip.

4. The structure of claim 3 further comprising:
a plurality of alignment motors configured to align the output ends of the plurality of optical fibers with the plurality of light coupling structures.

5. The structure of claim 1 wherein the housing includes a third interior chamber, and further comprising:
a microfluidics module configured to be received in the third interior chamber, the microfluidics module including the microfluidic circuit.

6. The structure of claim 1 wherein the fluid inside at least one of the reservoirs is a solution comprising a bio-functionalization chemistry.

7. The structure of claim 1 wherein the fluid inside at least one of the reservoirs is a solution comprising a preclean chemistry.

8. The structure of claim 7 wherein the fluid inside at least one of the reservoirs is a solution comprising a bio-functionalization chemistry.

9. A structure for use with a personal test unit, the structure comprising:
a first module configured to be inserted into the personal test unit, the first module including a first plurality of reservoirs, and at least one of the first plurality of reservoirs containing a first solution comprising a bio-functionalization chemistry.

10. The structure of claim 9 further comprising:
a second module configured to be inserted into the personal test unit, the second module including a second plurality of reservoirs, and at least one of the second plurality of reservoirs containing a second solution comprising a preclean chemistry.

11. The structure of claim 10 wherein the first module and the second module are configured to be inserted into an interior chamber of the personal test unit.

12. The structure of claim 9 wherein the first module includes a housing with plurality of outlets and a plurality of ducts, and the plurality of ducts respectively couple the first plurality of reservoirs with the plurality of outlets.

13. The structure of claim 9 wherein at least one of the first plurality of reservoirs contains a second solution comprising a preclean chemistry.

14. A method of administering a health-monitoring test, the method comprising:
inserting a sensor chip into a personal test unit;
delivering a first solution comprising a bio-functionalization chemistry from a first reservoir to a surface of the sensor chip after the sensor chip is inserted into the personal test unit; and
analyzing a sample of a bodily fluid placed on the surface after the first solution is delivered to the surface.

15. The method of claim 14 wherein the first solution is delivered by a microfluidics circuit.

16. The method of claim 15 wherein the surface of the sensor chip includes a sensing device, and analyzing the sample of the bodily fluid placed on the surface with the first solution comprising the bio-functionalization chemistry comprises:
transferring light from a laser to the sensing device on the sensor chip.

17. The method of claim 16 wherein the light is transferred by a light coupling structure from the laser to the sensing device on the sensor chip.

18. The method of claim 14 further comprising:
delivering a second solution comprising a preclean chemistry from a second reservoir to the surface before the first solution is delivered to the surface.

19. The method of claim 18 wherein the first reservoir is disposed in a first module inserted into the personal test unit, and the second reservoir is disposed in a second module inserted into the personal test unit.

20. The method of claim 19 wherein the first module and the second module are configured to be separately received in an interior chamber of the personal test unit.
